(19) United States
(12) Patent Application Publication
(10) Pub. No.: US 2005/0076653 A1
(43) Pub. Date: Apr. 14, 2005

(54) System for controlling cryogenic fluid flow rate and joule-thomson effect cooler comprising same

(76) Inventor: Dominique Chazot, Noyarey (FR)

Correspondence Address: Air Liquide;Intellectual Property Department, Suite 1800, 2700 Post Oak Boulevard, Houston, TX, 77056, US

(21) Appl. No.: 10/498,284

(22) PCT Filed: Nov. 20, 2002
(86) PCT No.: PCT/FR02/03972

(30) Foreign Application Priority Data
Dec. 5, 2001 (FR) 01/15706

(51) Int. Cl. F17C 13/00; F25B 19/02; G05D 23/02

(52) U.S. Cl. 62/51.2; 62/50.7; 236/101 R

(57) ABSTRACT

The invention concerns a flow rate control system comprising two components (1, 2) made of materials with different expansion ratios, one of said components (7) being arranged at least partially around the first (1, 2) component so as to normally provide an annular outlet (13) which is closed when the component (7) contracts, the passage of the gas to be expanded being then limited to a passageway with reduced cross-section in the central component, for example consisting in an axial groove (12). The invention is useful for producing any type or Joule-Thomson effect cooler.

The present invention relates to cryogenic fluid flow control systems of the type comprising a first element forming a fluid inlet channel and an outlet passage that can be selectively blocked off by a second element that can move relative to the first element by an effect due to the difference in expansion coefficients between the materials of the first and second elements.

Known flow control systems of this type, such as those described for example in documents FR-A-2 377 588 or EP-A-0 170 948, comprise a needle that can move longitudinally relative to an outlet orifice due to the effect of axial differential expansions between the first element having the orifice and a moveable device that includes a rod and/or a bellows supporting the needle, in an arrangement that is tricky to manufacture and assemble, and therefore expensive and with no guarantee of reliability, especially in the presence of vibrations.

The object of the present invention is to propose a system of the type defined above that is of simple, robust and inexpensive construction and is of greater reliability.

To do this, according to one aspect of the invention, the outlet passage comprises a part extending transversely relative to the fluid inlet channel and emerging on the periphery of an end region of the first element, the second element being placed at least partly around this end region.

According to more particular features of the invention:

the end region of the first element is approximately cylindrical and the second element is annular and coaxial with said end region;

the outlet passage includes a downstream part of reduced section that cannot be blocked off by the second element;

this downstream part consisting of an axial groove formed in the periphery of the end region or of a capillary tube that extends the inlet channel through the end region;

at least one of the first and second elements is made of a plastic or a metallic material.

The subject of the present invention is also a Joule-Thomson expansion cooler, especially for a cryostat, that includes such a cryogenic fluid flow control system.

Other features and advantages of the invention will become apparent from the following description of embodiments given by way of illustration, but implying no limitation, in conjunction with the appended drawings in which:

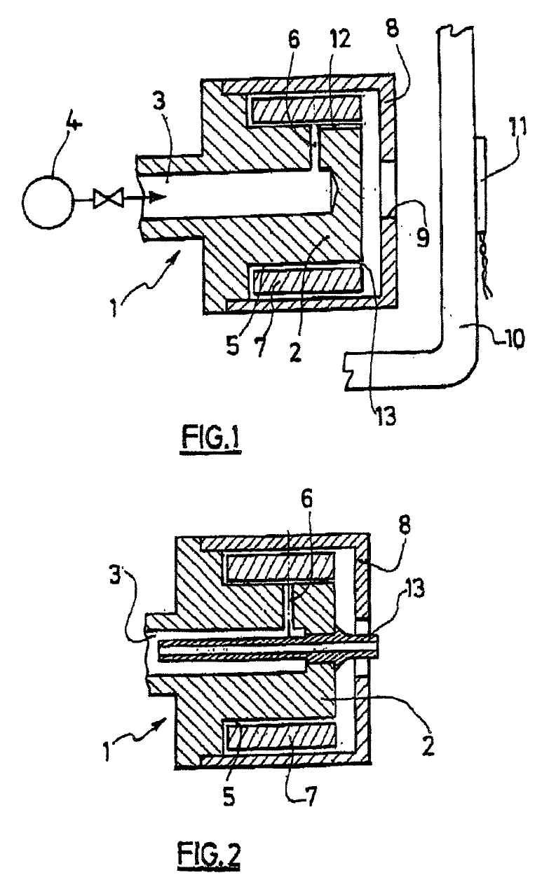

FIG. 1 is a schematic view in partial section of a first embodiment of the invention;

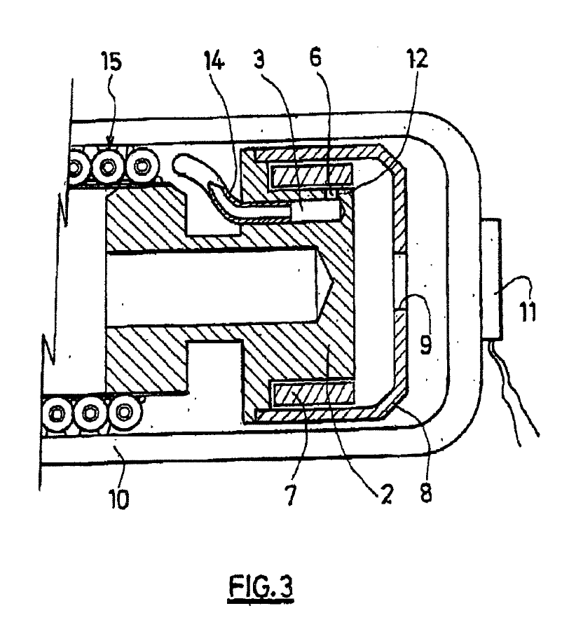

FIG. 2 is a schematic view similar to FIG. 1 of another embodiment of the invention; and

FIG. 3 is a partial view, in section, of a cryostat incorporating a Joule-Thomson cooler according to the invention.

In the description that follows and in the drawings, identical or similar elements bear the same reference numbers.

FIG. 1 shows the downstream end of one embodiment of a flow control system for a cryostat with a Joule-Thomson cooler.

This system comprises a first elongate element, denoted overall by the reference 1, which terminates in an end part 2 of enlarged diameter and along which first element there extends a blind bore 3 which selectively communicates with a source 4 of pressurized gas, for example nitrogen or argon.

According to one aspect of the invention, the end part 2 forms a cylindrical peripheral region 5 into which at least one radial transverse passage 6 emerges. Placed around the cylindrical peripheral region 5, normally loosely, is a second annular element or ring 7 held in place, in the example shown, around the peripheral region 5 by a cover 8 fitted over the end part 2 and provided with an axial orifice 9 facing the end wall 10 of a casing, for example made of metal, in which the flow control system is mounted, the said casing carrying, for example, an infrared detection cell 11. The ring 7 may be held in place around the peripheral region 5 by a simple stop, of the strap or pin type inserted into the end part 2. In the embodiment shown in FIG. 1, an axial groove 12 emerging upstream into the radial passage 6 and downstream into the lower face of the end part 2 is formed in the peripheral region 5.

The annular ring 7 is made of a material having an expansion coefficient substantially higher than that of the central element 1 and so the operation of the system is as follows:

Before injection of the gas to be expanded, that is to say at room temperature, an annular outlet passage 13 of cross section substantially larger than that of the passage 6 exists between the ring 7 and the surface 5.

When the cryogenic fluid is injected into the bore 3, its expansion upon leaving the flow control system via the passages 6 and 13 causes rapid cooling of the entire system, resulting in contraction of the ring 7 around the end part 2 and resulting in rapid disappearance of the annular outlet passage 13. Consequently, the compressed gas to be expanded can now escape only via the axial groove 12, that is to say with a much smaller flow rate than previously via the annular passage 13, thus making it possible to ensure continuous expansion for maintaining the refrigeration of the cryostat at the cost of a small tap-off of gas.

In the embodiment shown in FIG. 2, the gas outlet passage of small cross section is produced by a capillary tube 13 that passes through the end wall of the end part 2, being brazed to the latter and extending into the bore 3 forward of the radial passage 6 and advantageously beyond the opening 9 in the cover 8, in order to direct the reduced flow of cold fluid directly onto the region of the cell 11.

In the cryostat embodiment shown in FIG. 3, the flow control system is similar to that shown in FIG. 1, but the blind hole 3, where the radial passage 6 emerges, is offset laterally, in the end part 2, near the axial leakage groove 12, and the working gas is conveyed by a tube 14, the downstream end of which is fitted into the bore 3 and brazed thereto, and the upstream region of said tube has the shape of a spiral in order to form a heat exchanger coil 15 extending axially into the casing 10 of the cryostat.

For moderate gas pressures (not exceeding 200 bar), the element 1 may be made of a plastic, for example a polyamide, and the ring 7 may be made of a plastic, for example cavity Teflon™.

For moderated and high gas pressures, the elements 1 and 7 are made of metal, advantageously Invar and aluminum respectively. The ring 7 may also be made of copper or a copper alloy.

Although the invention has been described in relation to particular embodiments, it is not limited thereby but is capable of modifications and variants that will become apparent to a person skilled in the art within the context of the claims appended hereto. In particular, the invention may apply in any type of Joule-Thomson geometry, for example one that is conical or flat.

1-8. (canceled)

9. A cryogenic fluid flow control system apparatus, comprising:
a) a first element, wherein said first element comprises an end part with a periphery, and wherein said first element forms a fluid inlet channel and an outlet passage; and
b) a second element, that can move relative to the first element by an effect due to the difference in expansion coefficients between the materials of the first and second elements, thereby selectively blocking off the outlet passage with the second element, wherein the outlet passage comprises a part extending transversely relative to the inlet channel and emerging on the periphery of the end part of the first element, with the second element being placed at least partly around said end part.

10. The apparatus of claim 9, wherein said end part is approximately cylindrical and said second element is annular and coaxial with said end part.

11. The apparatus of claim 9, wherein said outlet passage further comprises a second part of reduced section that cannot be blocked off by said second element.

12. The apparatus of claim 11, wherein said second part of the outlet passage further comprises an axial groove formed in said periphery of the end part of the first element.

13. The apparatus of claim 11, wherein said second part of the outlet passage is formed by a capillary tube that extends the inlet channel through the end part of the first element.

14. The apparatus of claim 9, wherein at least one of said first and second elements comprises a plastic.

15. The apparatus of claim 9, wherein at least one of said first and second elements comprises a metallic material.

16. A Joule-Thomson cooler apparatus comprising a flow control system, wherein said flow control system comprises:
a) a first element, wherein said first element comprises an end part with a periphery, and wherein said first element forms a fluid inlet channel and an outlet passage; and
b) a second element, that can move relative to the first element by an effect due to the difference in expansion coefficients between the materials of the first and second elements, thereby selectively blocking off the outlet passage with the second element, wherein the outlet passage comprises a part extending transversely relative to the inlet channel and emerging on the periphery of the end part of the first element, with the second element being placed at least partly around said end part.
